(19) United States
(12) Patent Application Publication
(10) Pub. No.: US 2023/0028152 A1
(43) Pub. Date: Jan. 26, 2023

(54) DETERMINING LOCATIONS OF AN OBJECT USING OBJECT TRACKING INFORMATION AND A PREDICTIVE ANALYSIS MODULE

(71) Applicant: International Business Machines Corporation, Armonk, NY (US)

(72) Inventors: Nitika Sharma, Punjab (IN); Akash U. Dhoot, Pune (IN); Venkata Vara Prasad (Last name not provided), Visakhapatnam (IN); Chaitanya Korupolu, Visakhapatnam (IN); Shailendra Moyal, Pune (IN)

(21) Appl. No.: 17/381,122

(22) Filed: Jul. 20, 2021

(51) Int. Cl. G06N 5/04; G06F 16/29; G06N 5/02

(52) U.S. Cl. CPC G06N 5/04; G06F 16/29; G06N 5/022

(57) ABSTRACT

Provided are a computer program product, system, and method for determining locations of an object using object tracking information and a predictive analysis module. Object tracking information has information on properties of an object and locations of the object. An offload event included in the object tracking information indicates at least one of a location where the object was offloaded and a receiving person that received the object when offloaded. In response to a query for the object from a requestor, a response is returned to the requestor indicating a location at which the object was last offloaded from the object tracking information. A predictive analysis module is invoked to process information on a location of the requestor and on the object to predict a location where the object is currently located to return to the requestor.

### BACKGROUND OF THE INVENTION

### 1. Field of the Invention

The present invention relates to a computer program product, system, and method for determining locations of an object using object tracking information and a predictive analysis module.

### 2. Description of the Related Art

Often people may lose track of objects and not remember their location due to memory loss or forgetfulness. An inordinate amount of time may be consumed trying to locate previously placed objects in addition to the expense in having to replace a lost object, only to later locate the object after replacement. The inefficiency and frustration people experience while looking for misplaced objects is increasing as the number of objects people need to track in their daily life increases and as people live longer and suffer age related memory loss.

There is a need in the art for developing applications and technology to assist people in tracking objects to improve their lives and optimize time usage.

### SUMMARY

Provided are a computer program product, system, and method for determining locations of an object using object tracking information and a predictive analysis module. Object tracking information has information on properties of an object and locations of the object. An offload event is received from a personal computing device having information on a detected transfer of possession of the object. The offload event indicates at least one of a location where the object was offloaded and a receiving person that received the object when offloaded at the location. Information on the offload event is included in the object tracking information for the object. In response to a query for the object from a requestor, a response is returned to the requestor indicating a location at which the object was last offloaded from the object tracking information. A predictive analysis module is invoked to process information on a location of the requestor and on the object subject to the query to predict a location where the object is currently located. The predicted location of the object is returned to the requestor.

### BRIEF DESCRIPTION OF THE DRAWINGS

FIG. 1 illustrates an embodiment of a computing environment having a personal computing device and object tracking system.

FIG. 2 illustrates an embodiment of an offload event generated when offloading an object to a location or receiving person.

FIG. 3 illustrates an embodiment of object tracking information having information on instances in which an object has been offloaded to different locations and/or persons over time.

FIG. 4 illustrates an embodiment of an offload instance having information on a particular offloading of an object to a location and receiving person at an instant in time.

FIG. 5 illustrates an embodiment of user information.

FIG. 6 illustrates an embodiment of operations to generate an offload event upon detecting an offloading of an object to a location and receiving person.

FIG. 7 illustrates an embodiment of operations to update object tracking information for an object with a received offload event from a user for the object.

FIG. 8 illustrates an embodiment of operations to process a query from a requestor for a location of an object.

FIG. 9 illustrates an embodiment of operations to transmit a location of an object in response to a query for an object location.

FIG. 10 illustrates an embodiment of operations to invoke a predictive analysis module to predict a location of an object not located or found in response to a query.

FIG. 11 illustrates an embodiment of operations to train the predictive analysis module in response to feedback on whether a predicted location resulted in discovery of the object.

FIG. 12 illustrates a computing environment in which the components of FIG. 1 may be implemented.

### DETAILED DESCRIPTION

Described embodiments provide improvements to computer technology to assist in discovery of objects that are being tracked in an object tracking system and being interacted with by one or more users of the object tracking system. Described embodiments utilize a personal computing device to detect when an object is offloaded from one person, the offloader, to a location or a receiving person. This detected offload event may then be added to object tracking information for an object. Later a requestor may query the object tracking system for a location of the object. The object tracking system may determine the location by querying the object tracking information, such as using a database query. If the correct location cannot be located in the object tracking information, then described embodiments provide a predictive analysis module to use machine learning and artificial intelligence to predict locations of the object based on input information on the requestor and the object.

Described embodiments provide improvements to predictive analysis for object discovery by providing techniques to train the predictive analysis module with a historical corpus of data on the location of objects based on factors including information on a location of a requestor, locations of the object, and specifications of the object. Further described embodiments, provide improvements to technology for locating objects by deploying both a query of object tracking information to learn of a location of an object based on specific tracked information of the object and then using a predictive analysis module to supplement the predictions. For instance, if the results of the query of the object tracking information do not result in the object being discovered at the returned location or if the requestor does not have the appropriate authorizations to access the current object tracking information for the object, then the predictive analysis module may be invoked to provide an alternative means for locating the object based on a historical corpus of object discovery for other objects of the object type of the object for which the location is requested. In this way, machine learning and artificial intelligence are deployed to supplement the location results that may be derived from a database of object tracking information based on detected offload events for the object.

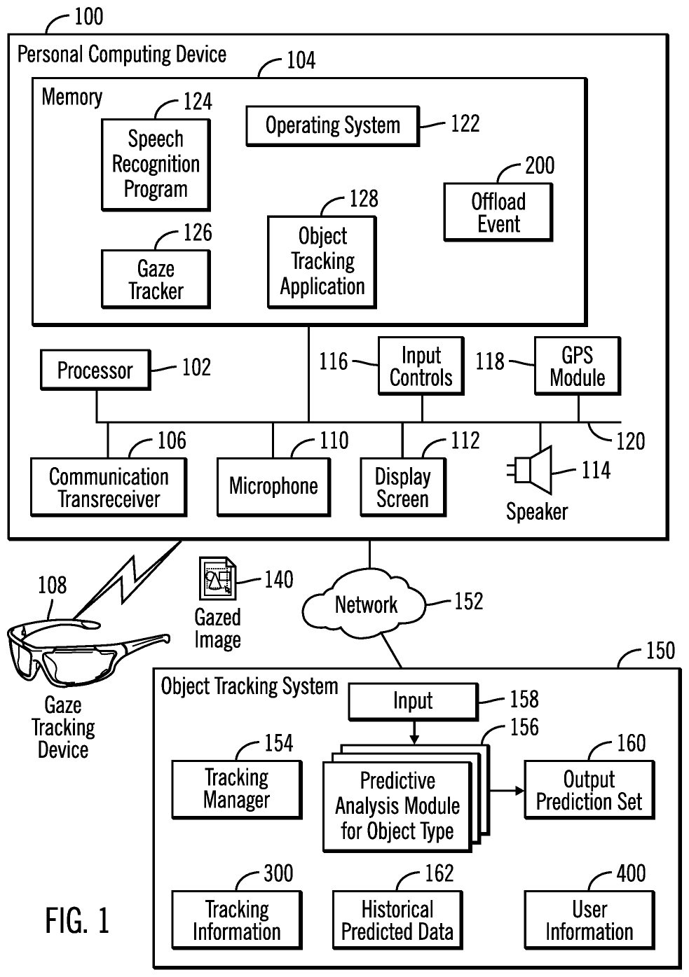

FIG. 1 illustrates an embodiment of a personal computing device 100 configured for use to assist a user in determining a location of items or physical objects. The personal computing device 100 includes a processor 102, a main memory 104, a communication transceiver 106 to communicate (via wireless communication or a wired connection) with external devices, including a wearable gaze tracking device 108; a microphone 110 to receive as input sound external to the personal computing device 100; a display screen 112 to render display output to a user of the personal computing device 100; a speaker 114 to generate sound output to the user; input controls 116 such as buttons and other software or mechanical buttons, including a keyboard, to receive user input; and a global positioning system (GPS) module 118 to determine a GPS portions of the personal computing device. The components 102-118 may communicate over one or more bus interfaces 120.

The main memory 104 may include various program components including an operating system 122 to manage the personal computing device 100 operations and interface with device components 102-120; a speech recognition program 124 to convert user received speech via the microphone 110 to text; a gaze tracker program 126 to interface with the gaze tracking device 108 to receive a gazed image 140 detected by eye tracking cameras that acquire the gazed image 140 on which the tracked eye is fixed; an object tracking application 128 to gather information on objects the user is tracking through the gaze tracking device 108 or speech detected through the microphone 110. The object tracking application 128 may produce an offload event 200 having information on a tracked object the user of the personal computing device 100 has offloaded to a location or to a receiving person. Further, the object tracking application 128 may receive a user request for location of an object, via text or speech, and then generate a query to the object tracking system 150 for the object location.

The personal computing device 100 may transfer object offload events 200 to an object tracking system 150 over a network 152. The object tracking system 150 maintains object tracking information 300 from multiple personal computing devices 100 and users to allow for tracking of objects between users. The object tracking system 150 may include a tracking manager 154 to manage offload events 200 from multiple personal computing devices 100 and to manage queries from the users of the personal computing devices 100 for information on a location of a tracked physical object indicated in the tracking information 300. The object tracking system 150 further has information on users 500 who are providing object tracking information to the object tracking system 150. The object tracking information 300 may be implemented in a database, such as a relational database or object oriented database, or other types of data structures, such as a structured tagged document.

The object tracking system 150 further maintains a predictive analysis module 156 for an object type to use machine learning and artificial intelligence to predict a location of a physical object if the location cannot be determined from the tracking information 300. The predictive analysis module 156 may receive as input 158 information on a location of a requestor seeking a location of an object type, descriptive information on the object, as well as any other useful information that could contribute to improved location predictions. The predictive analysis module may be trained to predict locations of an object of an object type based on a historical corpus of previous offload locations of objects of the object type based on different combinations of input. The output predictions may comprise a prediction set 160 of locations of the requested object with corresponding confidence levels for the predictions, indicating a probabilities the predictions are accurate. There may be different predictive analysis modules for different object types or one for multiple object types.

In certain embodiments, the predictive analysis module 156 may use machine learning and deep learning algorithms, such as decision tree learning, association rule learning, neural network, inductive programming logic, support vector machines, Bayesian network, etc. For artificial neural network program implementations, the neural network may be trained using backward propagation to adjust weights and biases at nodes in a hidden layer to produce the computed output. In backward propagation used to train a neural network machine learning module, biases at nodes in the hidden layer are adjusted accordingly to produce the output prediction set 160 having predicted locations and specified confidence levels for the predicted locations based on the input on the requestor and object. Backward propagation may comprise an algorithm for supervised learning of artificial neural networks using gradient descent. Given an artificial neural network and an error function, the method may calculate the gradient of the error function with respect to the neural network's weights and biases.

In backward propagation used to train a neural network machine learning module, such as the predictive analysis module 156, margin of errors are determined based on a difference of the calculated predictions and whether the object was located at the predicted location. This information on whether a predicted location resulted in the object being discovered at the predicted location may be used to modify the confidence levels of different predictions to adjust predicted locations of an object based on various input 158 factors. Biases at nodes in the hidden layer are adjusted accordingly to decrease reduce the confidence levels for predicted locations that did not result in locating the object and increase the confidence levels for predicted locations that did result in locating the object.

In certain embodiments, the predictive analysis module 156 machine learning algorithm may be trained using historical predicted data 162 on predicted locations that resulted in discovery of objects of the object type based on various factors, such as current location of requestor, description of the object, etc.

The arrows shown in FIG. 1 between the components and objects in the memory 104 represent a data flow between the components.

The personal computing device 100 may comprise a smart phone, personal digital assistance (PDA), or stationary computing device capable of processing user information observed through the gaze tracking device 108. The memory 104 may comprise non-volatile and/or volatile memory types, such as a Flash Memory (NAND dies of flash memory cells), a non-volatile dual in-line memory module (NVDIMM), DIMM, Static Random Access Memory (SRAM), ferroelectric random-access memory (FeTRAM), Random Access Memory (RAM) drive, Dynamic RAM (DRAM), storage-class memory (SCM), Phase Change Memory (PCM), resistive random access memory (RRAM), spin transfer torque memory (STM-RAM), conductive bridging RAM (CBRAM), nanowire-based non-volatile memory, magnetoresistive random-access memory (MRAM), and other electrically erasable programmable read only memory (EEPROM) type devices, hard disk drives, removable memory/storage devices, etc.

The bus 120 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The object tracking system 150 may comprise one or more servers or an enterprise class server providing cloud based object tracking services to registered users.

Generally, program modules, such as the program components 122, 124, 126, 128, 154, 156 may comprise routines, programs, objects, components, logic, data structures, and so on that perform particular tasks or implement particular abstract data types. The program modules may be practiced in distributed cloud computing environments where tasks are performed by remote processing devices that are linked through a communications network. In a distributed cloud computing environment, program modules may be located in both local and remote computer system storage media including memory storage devices.

The program components and hardware devices of the personal computing device 100 of FIG. 1 may be implemented in one or more computer systems, where if they are implemented in multiple computer systems, then the computer systems may communicate over a network.

The program components may be accessed by a processor from memory to execute. Alternatively, some or all of the program components 122, 124, 126, 128, 154, 156 may be implemented in separate hardware devices, such as Application Specific Integrated Circuit (ASIC) hardware devices.

The functions described as performed by the program components 122, 124, 126, 128, 154, 156 may be implemented as program code in fewer program modules than shown or implemented as program code throughout a greater number of program modules than shown.

The network 152 may comprise the Internet or one more interconnected Local Area Networks (LAN), Storage Area Networks (SAN), Wide Area Network (WAN), peer-to-peer network, wireless network, satellite network, etc.

In alternative embodiments, the components of the personal computing device 100 may be embedded in the gaze tracking device 108.

In the embodiment of FIG. 1, the management of tracking information 300 and the predictive analysis module 156 are implemented in a central object tracking system 150 that manages information and answers queries on location of objects for multiple personal computing devices 100 and users. In an alternative embodiment, some or all of the components of the object tracking system 150, including the tracking manager 154 to determine the location of objects, the tracking information 300, and the predictive analysis module 156, may be implemented in the personal computing device 100.

In certain embodiments, the object tracking information 300ᵢ may be implemented as part of a virtual representation of the object, such as the case with a digital twin. In such implementations, the predictive analysis module 156 may be part of the digital twin of the physical object to accurately reflect the physical object and simulate the location of the object. The described embodiments may integrate with a digital twin of the object to simulate various scenarios for predicting a discovery of the object, such as the International Business Machines® Digital Twin technology. The predictive analysis module 156 model for the digital twin of the object may perform discovery simulation based on various parameters like but not limited to, the object type, specification, metadata, context, locations, persona association, last time discovery, history data, people behavior, etc. The virtual representation or predictive analysis module 156 may tag each simulated scenario, including an association with the object type and provability of object discovery, such as in historical predicted data 162, for future training of the predictive analysis module 156. (International Business Machines is a trademark of International Business Machines Corporation throughout the world).

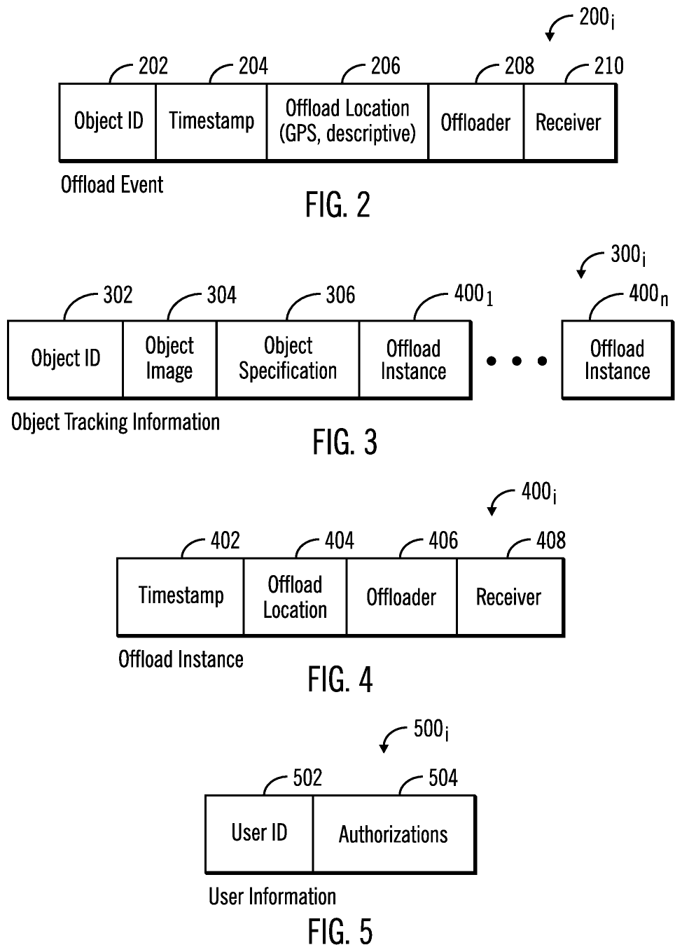

FIG. 2 illustrates an embodiment of an instance of an offload event 2001 generated by the object tracking application 128 that is created in response to the gaze tracker 126 or speech recognition program 124 detecting that the user of the personal computing device 100 have offloaded an object to a location or another person, referred to as the receiver. The offload event 2001 may comprise an object identifier (ID) 202 identifying the object being offloaded; a timestamp 204 indicating a time the object was offloaded, an offload location 206 that may comprise a geographical location, such as derived from the GPS module 118 and may include a description of the location, e.g., desk drawer, kitchen table, etc.; an offloader 208 comprising the user that offloaded the object; and a receiver 210 indicating a user that received the object being offloaded if the object was offloaded to a receiver. The offloader 208 may comprise a person or a machine, such as a robot.

FIG. 3 illustrates an embodiment of an instance of object tracking information 300ᵢ generated by the tracking manager 156 in response to an offload event 200ᵢ, and includes: an object ID 302 comprising the object ID 202 from the offload event 200ᵢ; an optional object image 304 comprising a still image or video of the object; an object specification 306 comprising descriptive details on the object, including size, shape, appearances, color, image or video snapshot, category, properties, etc.; and one or more offload instances 400₁ . . . 400ₙ for each offload event 2001 received for the object 302.

FIG. 4 illustrates an embodiment of an instance an offload instance 400ᵢ included in the object tracking information 300ᵢ and generated from a received offload event 2001, and includes: a timestamp 402 comprising the timestamp 204 from the offload event 2001 when the object was offloaded; an offload location 404, comprising the offload location 206 from the offload event 200ᵢ where the object 302 was offloaded; the offloader 406, comprising the offloader 208 from the offload event 2001 indicating the user that offloaded the object 302; and a receiver 408, comprising the receiver 210 from the offload event 200ᵢ indicating a receiver, if any, that received the offloaded object 302. The receiver 408 may be left as an empty field if the object was offloaded to a location and not a person or entity that could independently move the object.

With the embodiment of FIGS. 3 and 4, the object tracking information 300 has information on when an object has changed locations, such as moved to a location or offloaded to another user. The offload instances 400₁ . . . 400ₙ may be within the object tracking information 300ᵢ data structure or at a separate location identified in the object information 300ᵢ.

FIG. 5 illustrates an embodiment of an instance of user information 500ᵢ in the user information 500 for one user, and includes a user ID 502, uniquely identifying a user, and one or more authorizations 504 indicating a authorizations or security levels used to control access of the user 502 to different objects based on the authorizations of the user currently possessing the object.

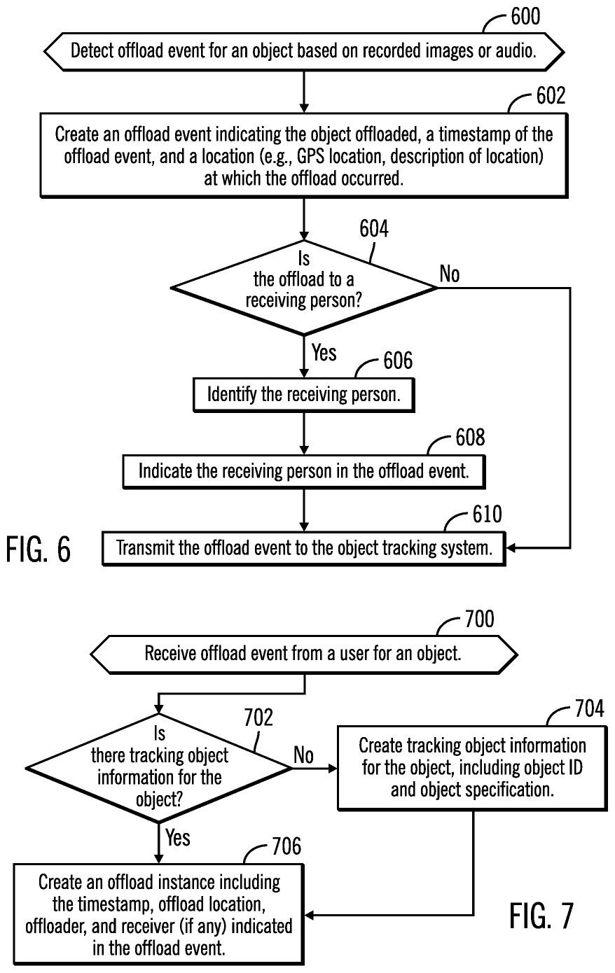

FIG. 6 illustrates an embodiment of operations performed by the object tracking application 128 to generate an offload event 200ᵢ upon detecting that a user of the personal computing device 100 has offloaded an object. The personal computing device 100 may detect an object offload via the gaze tracker 126 interpreting images and/or video of user movements through the gaze tracking device 108 with respect to the object or upon the speech recognition program 124 interpreting speech through the microphone 110 where the user describes offloading the object. Upon detecting the offload event, the object tracking application 128 creates an offload event 2001 indicating the object offloaded 202, a timestamp 204 of the offload event, a location 206 n (e.g., GPS location, description of location) at which the offload occurred, and the offloader 208 comprising the user of the personal computing device. If (at block 604) the personal computing device 100 detects the offload of the object is to a receiver, such as a receiving person, then the receiving person is identified (at block 606), such as by communicating with the receiving person's personal computing device 100, facial recognition, etc., and the identity of the receiving person is indicated (at block 608) in the receiver 210 field of the offload event 200ᵢ. From the no branch of block 604 or after indicating the receiving person 210, the offload event is transmitted (at block 610) to the object tracking system 150.

With the embodiment of FIG. 6, the personal computing device 100 creates an offload event 200ᵢ when the offload is no longer under control of the person currently possessing the object, such as by offloading to a location or handing over to another person or entity. The offload event is communicated to the object tracking system 150 to include in object tracking information 300ᵢ for the offloaded object.

FIG. 7 illustrates an embodiment of operations performed by the tracking manager 154 in the object tracking system 150, or elsewhere, to create or update object tracking information 300ᵢ upon receiving an offload event 200ᵢ from the personal computing device 100 for the object being tracked. Upon receiving (at block 700) an offload event 200ᵢ, if (at block 702) there is no object tracking information 300ᵢ for the object 202 indicated in the offload event 200ᵢ, then the tracking manager 154 creates (at block 704) an object tracking information instance 300ᵢ for the object, including the object ID 302 and object specification 306. From block 704 or if there already exists object tracking information 300ᵢ for the object, the tracking manager 154 creates (at block 706) and offload instance 400ᵢ for the received offload event 2001 including the timestamp 402 of the event, offload location 404, offloader 406, and receiver 408 (if any) indicated in fields 204, 208, and 210 of the received offload event 2001.

With the embodiment of FIG. 7, the tracking manager 154 can track a chain of custody of the object by recording offload instances 400ᵢ in object tracking information 300ᵢ for the object from offload events 200ᵢ generated at personal computing devices 100 of users in the system. Described embodiments, allow changes in the chain of custody of an object among different participating users 500 in the object tracking system 150.

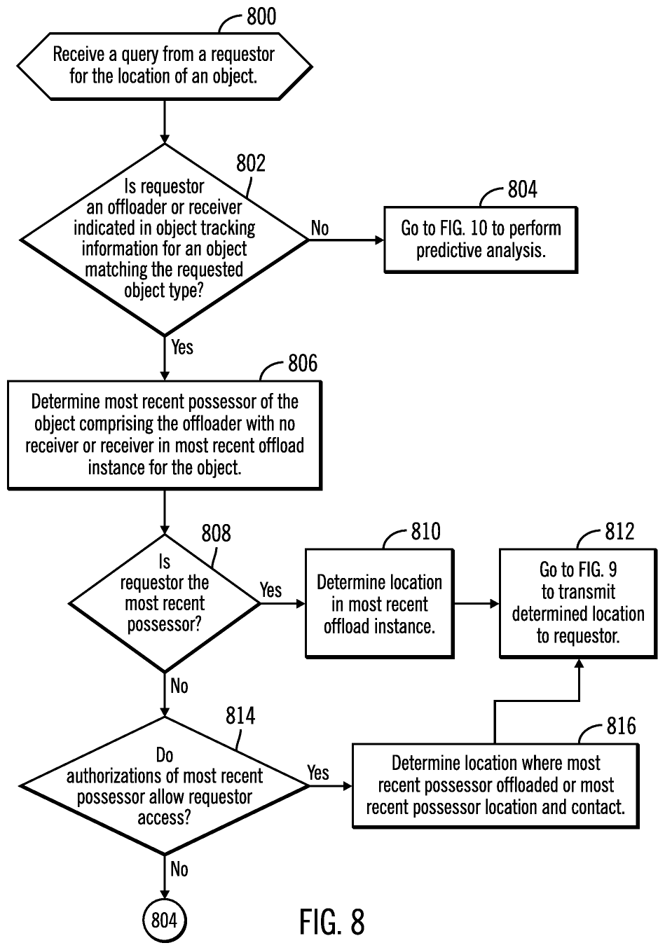

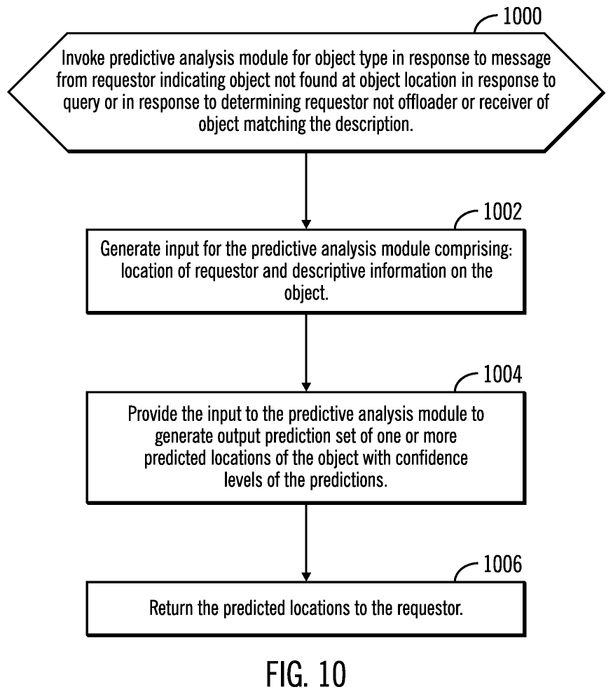

FIG. 8 illustrates an embodiment of operations performed by the tracking manager 154, or other component, to process a query for an object from a requestor at a personal computing device 100, such as via the object tracking application 128. Upon receiving (at block 800) a query from a requestor at a personal computing device 100_{R} for a location of an object, the tracking manager 154 determines (at block 802) whether the requestor is an offloader 406 or receiver 408 indicated in object tracking information 300ᵢ for an object matching the requested object type, such as having matching object specification 306. If (at block 802) the requestor is not an offloader 406 nor a receiver 408, then control proceeds (at block 804) to FIG. 10 to invoke the predictive analysis module 156 to determine a location of an object based on historical location determinations for objects of the object type. If (at block 802) the requestor is an offloader 406 or receiver 408, then a determination is made of a most recent possessor of the object 302 comprising the offloader 406 with no receiver or a receiver 408 in a most recent offload instance 400ₙ for the object 302.

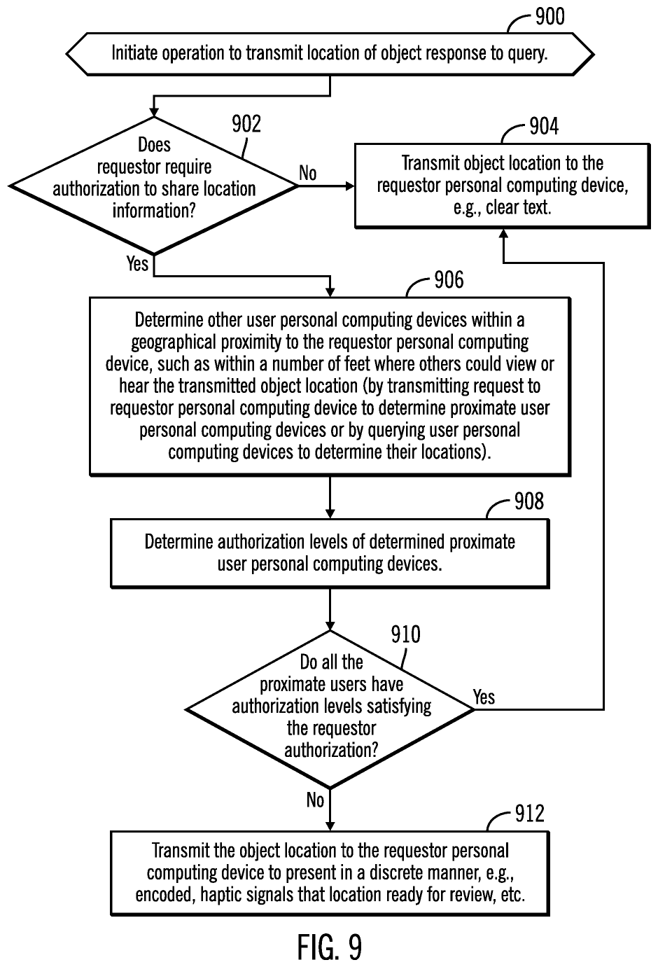

If (at block 808) the requestor is the most recent possessor, then the location 404 of the object in the most recent offload instance 400ₙ is determined (at block 810) and control proceeds to FIG. 9 to transmit the location information to the requestor personal computing device 100_{R}. If (at block 808) the requestor is not the most recent possessor, then the tracking manager 154 determines (at block 814) whether the authorizations 504 of the most recent possessor in user information 500_{P} for the most recent possessor allow the requestor access, based on authorizations 504 in the user information 500_{R} for the requestor. If (at block 814) the requestor is allowed to access to the location according to authorizations 504, then the tracking manager 154 determines (at block 816) the location where the most recent possessor offloaded the object, as in field 404 of most recent offload instance 400ₙ or determine the location of the most recent possessor. Control then proceeds (at block 812) FIG. 9 to report the location 404 or most recent possessor information to the requestor. If (at block 814) the authorizations 504 of the most recent possessor do not permit the requestor access, then control proceeds (at block 804) to FIG. 10 to invoke the predictive analysis module 156 to predict the location for the object.

With the embodiment of FIG. 8, the object tracking information 300 is used to respond to queries for location of objects from a requestor. If the requestor is not the most recent possessor of the object, then the tracking manager 154 determines whether the requestor has proper authorization to learn of the location of the object from the current possessor or recent offloader of the object to ensure user privacy and security is maintained. Further, if the requestor is not authorized to learn of the specific location of the object through a database query of the object tracking information 300, then the predictive analysis module 156 may be invoked to predict a location of the objection using machine learning/artificial intelligence.

In a further embodiment, the object itself may be part of a category that has a pre-defined security policy so that only requestors satisfying the object security policy can obtain location information from the object tracking information 300ᵢ for the object.

The response to the query may indicate the location in terms of GPS location, longitude and latitude on a map, as well as a description of the location. Further, the location information may include information on the chain of possession of the object, e.g., “You had received the house keys from Person-A and you kept them into drawer at XYZ” location”, “You had handed over the house keys to Person-B and Person-B placed them in a drawer at “XYZ“location”.

FIG. 9 illustrates an embodiment of operations performed by the tracking manager 154 to determine how to transmit the location information for an object to a requestor in response to a query in a secure manner. Upon initiating (at block 900) the operation to transmit the location information to the requestor in response to the query, a determination is made (at block 902) whether the requestor requires authorization 504 in the user information 500_{R} for the requestor to share location information. If (at block 902) authorization is not required to share location information, then the object location is transmitted (at block 904) to the requestor personal computing device 100_{R} as clear text, such as in a text or voice communication. If (at block 902) authorization is required, then the tracking manager 154 determines (at block 906) other proximate user personal computing devices 100_{PU} (“PU” references proximate users) within a geographical proximity to the requestor personal computing device 100_{R}, such as within a number of feet where users of the proximate personal computing devices 100_{PU} could view or hear the transmitted object location. The tracking manager 154 may transmit a request to the requestor personal computing device 100_{R} to determine proximate user personal computing devices or by querying user personal computing devices to determine their locations. The tracking manager 154 determines (at block 908) the authorization levels 504 in the user information 500_{PU} for the determined proximate users. In alternative embodiments, the authorization level may be determined from authorizations defined for objects of the object type.

If (at block 910) all the determined proximate users 500_{PU} have authorization levels 504 satisfying the requestor or object authorization, then control proceeds to block 904 to transmit the location information to the requestor personal computing device 100_{R} without encrypting or concealing the information. Otherwise, if all the proximate users do not have the required authorization levels, then the object location is transmitted (at block 912) to the requestor personal computing device to then present to the user in a discrete manner, such as an encrypted or encoded message, using haptic signals that the location is ready to review so the requestor may review discretely, etc.

FIG. 9 illustrates an embodiment of operations performed by the tracking manager 154. In an alternative embodiment, the operations of FIG. 9 may be performed by the object tracking application 128 upon receiving the location from the object tracking system 150 to determine how to determine whether to present the location information to the user in a discrete manner, such as an encoded message or haptic signals, or to present without limitations, via text message or voice message.

With the embodiment of operations of FIG. 9, before location information is presented to the requestor through their personal computing device 100_{R}, a determination is made whether the message needs to be somehow cloaked or presented in a discrete manner if there are other users in proximity to the requestor that do not have the authorization to here of the location of the object.

FIG. 10 illustrates an embodiment of operations performed by the predictive analysis module 156 upon being invoked to determine a location of an object. The predictive analysis module 156 of an object type of the requested object may be invoked (at block 1000) in response to message from requestor indicating object not discovered at the object location returned in response to a query or in response to determining the requestor is not the offloader or receiver of object matching the description in most recent offload instance for the matching object. Input 158 is generated (at block 1002) comprising one or more of a location of the requestor, a description of the object, and, if available, a location of where the requestor offloaded the object, such as included in an offload instance 400ᵢ in the object tracking information 300ᵢ. The input 158 is provided (at block 1004) to the predictive analysis module 156 to generate an output prediction set 160 of one or more predicted locations of the object with confidence levels of the predictions. The predicted locations are returned (at block 1006) to consider.

With the described embodiments, if the location of an object cannot be discovered from the object tracking information 300ᵢ for an object, then a predictive analysis module 156 may be invoked to determine a location without using specific information for the object being requested, that may involve authorization from a current possessor of the object. The predictive analysis module 156 may be trained with historical data on predicted object locations and the result of that prediction to determine output predictions based on characteristics of the requestor, characteristics of the object and information on a last location the requestor possessed the object.

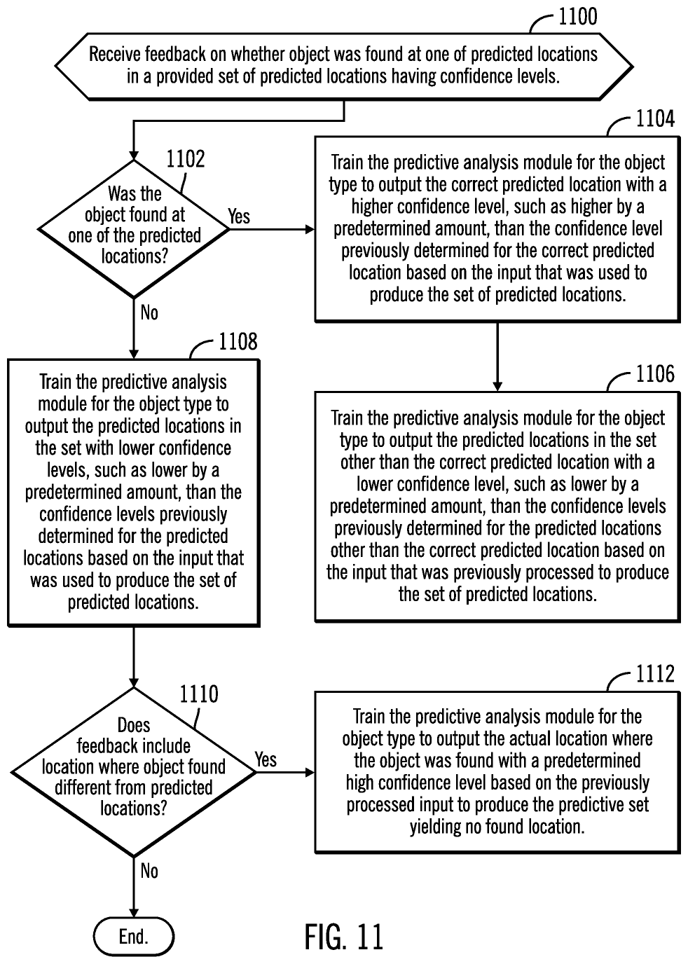

FIG. 11 illustrate an embodiment of operations performed by the predictive analysis module 156 to retrain the predictive analysis module 156 to adjust output 160 based on user feedback as to whether the searched object was in fact discovered at a predicted location. Upon receiving (at block 1100) feedback from a requestor on whether the sought object was discovered at one of the predicted locations in a provided set 160 of predicted locations having confidence levels, the predictive analysis module determines (at block 1102) whether the object was found at one of the predicted locations. The predicted analysis module 156 may save both the output set of predicted locations 160 and corresponding confidence levels and the input 158 used to generate the set 160 for subsequent retraining. If (at block 1102) the object was found at one of the predicted locations, then the predictive analysis module 156 for the object type is trained (at block 1104) to output the correct predicted location with a higher confidence level, such as higher by a predetermined amount, than the confidence level previously determined for the correct predicted location based on the input 158 that was processed to produce the set of predicted locations, including the correct predicted location. The predictive analysis module 156 is further trained to output the predicted locations in the set other than the correct predicted location with a lower confidence level, such as lower by a predetermined amount, than the confidence levels previously determined for the predicted locations other than the correct predicted location based on the input 158 that was previously processed to produce the set 160 of predicted locations. The retraining may involve backward propagation to adjust biases at nodes in a hidden layer to increase or decrease the confidence levels of the outputted predictions.

If (at block 1102) the feedback indicates the object was not found at any of the output predicted locations 160, then the predictive analysis module 156 is retrained (at block 1104) to output the predicted locations in the set with lower confidence levels, such as lower by a predetermined amount, than the confidence levels previously determined for the predicted locations based on the input 158 that was previously used to produce the set of predicted locations. If (at block 1110) the feedback includes the location the object was found different from the predicted locations, then the predictive analysis module 156 for the object type is trained (at block 1112) to output the actual location where the object was found with a predetermined high confidence level based on the previously processed input to produce the predictive set yielding no object discovery.

With the embodiment of FIG. 11, the predictive analysis module may be continually adjusted and retrained to improve the predictions based on user feedback to produce the correct predicted location with a higher confidence level and produce incorrect predicted locations with a lower confidence level.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

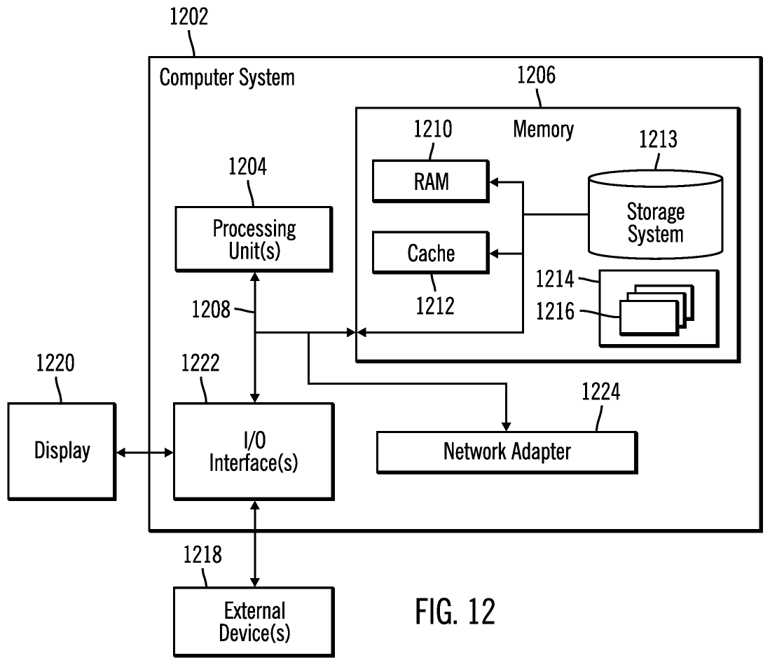

The computational components of FIG. 1, including the personal computing device 100 and the object tracking system 150, may be implemented in one or more computer systems, such as the computer system 1202 shown in FIG. 12. Computer system/server 1202 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1202 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, the computer system/server 1202 is shown in the form of a general-purpose computing device. The components of computer system/server 1202 may include, but are not limited to, one or more processors or processing units 1204, a system memory 1206, and a bus 1208 that couples various system components including system memory 1206 to processor 1204. Bus 1208 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1202 typically includes a variety of computer system readable media. Such media may be any available media that is accessible by computer system/server 1202, and it includes both volatile and non-volatile media, removable and non-removable media.

System memory 1206 can include computer system readable media in the form of volatile memory, such as random access memory (RAM) 1210 and/or cache memory 1212. Computer system/server 1202 may further include other removable/non-removable, volatile/non-volatile computer system storage media. By way of example only, storage system 1213 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1208 by one or more data media interfaces. As will be further depicted and described below, memory 1206 may include at least one program product having a set (e.g., at least one) of program modules that are configured to carry out the functions of embodiments of the invention.

Program/utility 1214, having a set (at least one) of program modules 1216, may be stored in memory 1206 by way of example, and not limitation, as well as an operating system, one or more application programs, other program modules, and program data. Each of the operating system, one or more application programs, other program modules, and program data or some combination thereof, may include an implementation of a networking environment. The components of the computer 1202 may be implemented as program modules 1216 which generally carry out the functions and/or methodologies of embodiments of the invention as described herein. The systems of FIG. 1 may be implemented in one or more computer systems 1202, where if they are implemented in multiple computer systems 1202, then the computer systems may communicate over a network.

Computer system/server 1202 may also communicate with one or more external devices 1218 such as a keyboard, a pointing device, a display 1220, etc.; one or more devices that enable a user to interact with computer system/server 1202; and/or any devices (e.g., network card, modem, etc.) that enable computer system/server 1202 to communicate with one or more other computing devices. Such communication can occur via Input/Output (I/O) interfaces 1222. Still yet, computer system/server 1202 can communicate with one or more networks such as a local area network (LAN), a general wide area network (WAN), and/or a public network (e.g., the Internet) via network adapter 1224. As depicted, network adapter 1224 communicates with the other components of computer system/server 1202 via bus 1208. It should be understood that although not shown, other hardware and/or software components could be used in conjunction with computer system/server 1202. Examples, include, but are not limited to: microcode, device drivers, redundant processing units, external disk drive arrays, RAID systems, tape drives, and data archival storage systems, etc.

The letter designators, such as i and n, used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for maintaining location information for objects tracked by personal computing devices, the computer program product comprising a computer readable storage medium having computer readable program code embodied therein that executes to perform operations, the operations comprising:
maintaining object tracking information on an object having information on properties of the object and locations of the object;
receiving, from a personal computing device, an offload event having information on a detected transfer of possession of the object, wherein the offload event indicates at least one of a location where the object was offloaded and a receiving person that received the object when offloaded at the location;
including information on the offload event in the object tracking information for the object;
in response to a query for the object from a requestor, returning a response to the requestor indicating a location at which the object was last offloaded from the object tracking information;
invoking a predictive analysis module to process information on a location of the requestor and on the object subject to the query to predict a location where the object is currently located; and
returning the predicted location of the object to the requestor.

2. The computer program product of claim 1, wherein in response to the query for the object from the requestor, performing:
determining from the object tracking information for the object whether the requestor is a most recent possessor of the object having offloaded the object; and
in response to determining that the requestor is the most recent possessor, returning, to the requestor, information on a most recent location where the object was offloaded.

3. The computer program product of claim 1, wherein the operations further comprise:
in response to determining that the requestor had offloaded the object to a receiver and the receiver subsequently offloaded the object in most recent object tracking information for the object, determining whether the requestor is authorized to access information on the object from the receiver; and
returning information on a most recent location where the object was offloaded to the requestor in response to determining that the requestor is authorized to access information on the object from the receiver.

4. The computer program product of claim 3, wherein the predictive analysis module is invoked in response to determining that the requestor is not authorized to access information on the object from the receiver.

5. The computer program product of claim 1, wherein the predictive analysis module is invoked in response to the requestor indicating that the object was not located at the location returned in the response to the query.

6. The computer program product of claim 1, wherein the operations further comprise:
determining whether at least one adjacent user personal computing device within a geographical proximity to the requestor has authorization to receive the location returned in response to the query; and
transmitting information on the location of the object in a discrete manner to the requestor that does not disclose the location of the object to the at least one adjacent user personal computing device within the geographical proximity in response to determining that the at least one adjacent user personal computing device within the geographical proximity does not have the authorization to receive the location.

7. The computer program product of claim 1, wherein the predictive analysis module comprises a machine learning module that outputs a plurality of predicted locations with confidence levels as a result of being trained with historical outcomes of location predictions of objects of an object type, wherein the operations further comprise:
receiving indication from the requestor that the object was located at an indicated predicted location of the predicted locations;
training the machine learning module to output the indicated predicted location with a higher confidence level than was outputted with the indicated predicted location; and
training the machine learning module to output the predicted locations other than the indicated predicted location with lower confidence levels than were outputted with the predicted locations other than the indicated predicted locations.

8. The computer program product of claim 1, wherein the predictive analysis module comprises a machine learning module that outputs a plurality of predicted locations with confidence levels, wherein the operations further comprise:
receiving indication from the requestor that the object was located at an indicated predicted location other than the predicted locations outputted by the machine learning module;
training the machine learning module to output the indicated predicted location with a predetermined high confidence level; and
training the machine learning module to output the predicted locations with lower confidence levels than were outputted with the predicted locations.

9. A system for maintaining location information for objects tracked by personal computing devices, comprising:
a processor; and
a computer readable storage medium having computer readable program code embodied therein that when executed by the processor performs operations, the operations comprising:
maintaining object tracking information on an object having information on properties of the object and locations of the object;
receiving, from a personal computing device, an offload event having information on a detected transfer of possession of the object, wherein the offload event indicates at least one of a location where the object was offloaded and a receiving person that received the object when offloaded at the location;
including information on the offload event in the object tracking information for the object;
in response to a query for the object from a requestor, returning a response to the requestor indicating a location at which the object was last offloaded from the object tracking information;
invoking a predictive analysis module to process information on a location of the requestor and on the object subject to the query to predict a location where the object is currently located; and
returning the predicted location of the object to the requestor.

10. The system of claim 9, wherein in response to the query for the object from the requestor, performing:
determining from the object tracking information for the object whether the requestor is a most recent possessor of the object having offloaded the object; and
in response to determining that the requestor is the most recent possessor, returning, to the requestor, information on a most recent location where the object was offloaded.

11. The system of claim 9, wherein the operations further comprise:
in response to determining that the requestor had offloaded the object to a receiver and the receiver subsequently offloaded the object in most recent object tracking information for the object, determining whether the requestor is authorized to access information on the object from the receiver; and
returning information on a most recent location where the object was offloaded to the requestor in response to determining that the requestor is authorized to access information on the object from the receiver.

12. The system of claim 9, wherein the operations further comprise:
determining whether at least one adjacent user personal computing device within a geographical proximity to the requestor has authorization to receive the location returned in response to the query; and
transmitting information on the location of the object in a discrete manner to the requestor that does not disclose the location of the object to the at least one adjacent user personal computing device within the geographical proximity in response to determining that the at least one adjacent user personal computing device within the geographical proximity does not have the authorization to receive the location.

13. The system of claim 9, wherein the predictive analysis module comprises a machine learning module that outputs a plurality of predicted locations with confidence levels as a result of being trained with historical outcomes of location predictions of objects of an object type, wherein the operations further comprise:
receiving indication from the requestor that the object was located at an indicated predicted location of the predicted locations;
training the machine learning module to output the indicated predicted location with a higher confidence level than was outputted with the indicated predicted location; and
training the machine learning module to output the predicted locations other than the indicated predicted location with lower confidence levels than were outputted with the predicted locations other than the indicated predicted locations.

14. The system of claim 9, wherein the predictive analysis module comprises a machine learning module that outputs a plurality of predicted locations with confidence levels, wherein the operations further comprise:
receiving indication from the requestor that the object was located at an indicated predicted location other than the predicted locations outputted by the machine learning module;
training the machine learning module to output the indicated predicted location with a predetermined high confidence level; and
training the machine learning module to output the predicted locations with lower confidence levels than were outputted with the predicted locations.

15. A method for maintaining location information for objects tracked by personal computing devices, comprising:
maintaining object tracking information on an object having information on properties of the object and locations of the object;
receiving, from a personal computing device, an offload event having information on a detected transfer of possession of the object, wherein the offload event indicates at least one of a location where the object was offloaded and a receiving person that received the object when offloaded at the location;
including information on the offload event in the object tracking information for the object;
in response to a query for the object from a requestor, returning a response to the requestor indicating a location at which the object was last offloaded from the object tracking information;
invoking a predictive analysis module to process information on a location of the requestor and on the object subject to the query to predict a location where the object is currently located; and
returning the predicted location of the object to the requestor.

16. The method of claim 15, wherein in response to the query for the object from the requestor, performing:
determining from the object tracking information for the object whether the requestor is a most recent possessor of the object having offloaded the object; and
in response to determining that the requestor is the most recent possessor, returning, to the requestor, information on a most recent location where the object was offloaded.

17. The method of claim 15, further comprising:
in response to determining that the requestor had offloaded the object to a receiver and the receiver subsequently offloaded the object in most recent object tracking information for the object, determining whether the requestor is authorized to access information on the object from the receiver; and
returning information on a most recent location where the object was offloaded to the requestor in response to determining that the requestor is authorized to access information on the object from the receiver.

18. The method of claim 15, further comprising:
determining whether at least one adjacent user personal computing device within a geographical proximity to the requestor has authorization to receive the location returned in response to the query; and
transmitting information on the location of the object in a discrete manner to the requestor that does not disclose the location of the object to the at least one adjacent user personal computing device within the geographical proximity in response to determining that the at least one adjacent user personal computing device within the geographical proximity does not have the authorization to receive the location.

19. The method of claim 15, wherein the predictive analysis module comprises a machine learning module that outputs a plurality of predicted locations with confidence levels as a result of being trained with historical outcomes of location predictions of objects of an object type, further comprising:
receiving indication from the requestor that the object was located at an indicated predicted location of the predicted locations;
training the machine learning module to output the indicated predicted location with a higher confidence level than was outputted with the indicated predicted location; and
training the machine learning module to output the predicted locations other than the indicated predicted location with lower confidence levels than were outputted with the predicted locations other than the indicated predicted locations.

20. The method of claim 15, wherein the predictive analysis module comprises a machine learning module that outputs a plurality of predicted locations with confidence levels, further comprising:
receiving indication from the requestor that the object was located at an indicated predicted location other than the predicted locations outputted by the machine learning module;
training the machine learning module to output the indicated predicted location with a predetermined high confidence level; and
training the machine learning module to output the predicted locations with lower confidence levels than were outputted with the predicted locations.
